(19) United States
(12) Patent Application Publication
(10) Pub. No.: US 2026/0341758 A1
(43) Pub. Date: Oct. 29, 2026

(54) APPARATUS FOR CONTROLLING OPERATION OF FUEL CELL SYSTEM AND METHOD THEREOF

(71) Applicants: Hyundai Motor Company, Seoul (KR); Kia Corporation, Seoul (KR)

(72) Inventors: Sae Byeok SEUNG, Hwaseong-Si (KR); Jo Young Lee, Hwaseong-Si (KR)

(73) Assignees: Hyundai Motor Company, Seoul (KR); Kia Corporation, Seoul (KR)

(21) Appl. No.: 19/329,912

(22) Filed: Sep. 16, 2025

(30) Foreign Application Priority Data
Apr. 28, 2025 (KR) 10-2025-0055680

(51) Int. Cl. H01M 8/04746; B60L 58/30; H01M 8/04082; H01M 8/04111; H01M 8/0438; H01M 16/00

(52) U.S. Cl. CPC H01M 8/04753; B60L 58/30; H01M 8/04111; H01M 8/04201; H01M 8/04395; H01M 8/04776; H01M 16/006; B60L 2240/12; B60L 2240/642; H01M 2220/20; H01M 2250/20; H01M 2250/402

(57) ABSTRACT

In an apparatus for controlling an operation of a fuel cell system and a method thereof, the apparatus includes a first valve that controls an amount of air supplied to a fuel cell stack, a second valve that discharges the air supplied to the fuel cell stack to an outside of the fuel cell stack, an air compressor that supplies the air to the fuel cell stack, a sensor that measures a speed of a vehicle disposed with the fuel cell stack, and a controller that closes the first valve, opens the second valve, and operates the air compressor, and closes the first valve, opens the second valve, and operates the air compressor when entering an idle stop mode while the speed of the vehicle exceeds a first threshold.

### CROSS-REFERENCE TO RELATED APPLICATION

The present application claims the benefit of priority to Korean Patent Application No. 10-2025-0055680, filed on Apr. 28, 2025, the entire contents of which are incorporated herein by reference.

### FIELD OF THE PRESENT DISCLOSURE

The present disclosure relates to a technology for controlling the operation of a fuel cell system disposed in a fuel cell vehicle.

### BACKGROUND

In general, a fuel cell vehicle (e.g., a hydrogen electric vehicle) includes a fuel cell stack in which multiple fuel cells used as a power source are stacked, a fuel supply system that supplies hydrogen as a fuel to the fuel cell stack, an air supply system that supplies oxygen as an oxidizer necessary for electrochemical reactions, and a water and heat management system that controls the temperature of the fuel cell stack.

The fuel supply system depressurizes the compressed hydrogen inside the hydrogen tank and supplies it to the fuel electrode (anode) of the stack, and the air supply system operates an air blower to supply the drawn outside air to the air electrode (cathode) of the stack.

When hydrogen is supplied to the fuel electrode of the stack and oxygen is supplied to the air electrode, hydrogen ions are separated through a catalytic reaction at the fuel electrode. The separated hydrogen ions are transferred to the cathode, which is the air electrode, through the electrolyte membrane, and at the cathode, the hydrogen ions separated from the fuel electrode, along with electrons and oxygen, cause an electrochemical reaction, thereby obtaining electrical energy. Specifically, electrochemical oxidation of hydrogen occurs at the fuel electrode, and electrochemical reduction of oxygen occurs at the air electrode. In the instant case, electricity and heat are generated by the movement of generated electrons, and vapor or water is generated by the chemical reaction of combining hydrogen and oxygen.

An exhaust device is provided to exhaust unreacted hydrogen and oxygen, and by-products such as water vapor, water, and heat generated during the electrical energy generation process of the fuel cell stack, and gases such as water vapor, hydrogen, and oxygen are exhausted into the atmosphere through an exhaust passage.

Components such as an air blower, a hydrogen recirculation blower, and a water pump configured for driving the fuel cell stack may be connected to a main bus terminal to facilitate driving the fuel cell stack, and the main bus terminal may be connected to various relays for facilitating power cutoff and connection and a diode for preventing reverse current from flowing to the fuel cell stack.

Dry air supplied through an air blower is humidified through a humidifier and then supplied to the cathode (air electrode) of the fuel cell stack. The exhaust gas of the cathode may be humidified by the water component generated therein and then may be transferred to the humidifier so that the exhaust gas is used to humidify dry air supplied to the cathode by the air blower.

Meanwhile, to improve the fuel efficiency of a fuel cell vehicle, an operation of stopping and restarting the power generation of a fuel cell while driving (fuel cell stop and fuel cell restart), that is, an idle stop operation of temporarily stopping the power generation of a fuel cell in the fuel cell vehicle, and an operation of controlling the ON/OFF of the fuel cell may be considered important.

According to a conventional technique for controlling the operation of a fuel cell system, when entering an idle stop mode, the air compressor that supplies air to the cathode of the fuel cell stack is stopped. Thus, the air supplied to the fuel cell stack gradually decreases, causing the output voltage of the fuel cell stack to gradually decrease, and the power generation of the fuel cell stops.

Accordingly, according to such a conventional technology, when the idle stop mode is released, the time for the air compressor to start and reach a reference RPM, the time for air to move from the air compressor to the interior of the fuel cell stack, and the time for air to sufficiently diffuse inside the fuel cell stack may cause an output delay (or response delay) of the fuel cell stack.

The matters described in this background section are intended to promote an understanding of the background of the present disclosure and may include matters that are not already known to those of ordinary skill in the art.

### BRIEF SUMMARY

The present disclosure has been made to solve the above-mentioned problems occurring in the related art while advantages achieved by the related art are maintained intact.

According to various aspects of the present disclosure, the present disclosure provides an apparatus for controlling an operation of a fuel cell system and a method thereof configured for preventing an output delay (or response delay) of a fuel cell stack that occurs when an idle stop mode is released by closing an air flow control valve (ACV) that is configured to control the amount of air supplied to the fuel cell stack, opening a bypass valve that discharges air supplied to the fuel cell stack to an outside of the fuel cell stack, and operating an air compressor that supplies air to the fuel cell stack when entering the idle stop mode.

According to various aspects of the present disclosure, the present disclosure provides an apparatus for controlling an operation of a fuel cell system and a method thereof configured for preventing an output delay of a fuel cell stack that occurs when an idle stop mode is released by closing an ACV that is configured to control the amount of air supplied to the fuel cell stack, opening a bypass valve that discharges air supplied to the fuel cell stack to an outside of the fuel cell stack, and operating an air compressor that supplies air to the fuel cell stack when entering the idle stop mode while the vehicle speed exceeds a threshold.

According to various aspects of the present disclosure, the present disclosure provides an apparatus for controlling an operation of a fuel cell system and a method thereof configured for preventing an output delay of a fuel cell stack that occurs when an idle stop mode is released by closing an ACV that is configured to control the amount of air supplied to the fuel cell stack, opening a bypass valve that discharges air supplied to the fuel cell stack to an outside of the fuel cell stack, and operating an air compressor that supplies air to the fuel cell stack when entering the idle stop mode while the vehicle speed exceeds a first threshold and the available output of a high-voltage battery does not exceed a second threshold.

According to various aspects of the present disclosure, the present disclosure provides an apparatus for controlling an operation of a fuel cell system and a method thereof configured for improving the fuel efficiency of a fuel cell vehicle by maintaining a bypass valve for discharging air supplied to a fuel cell stack to an outside of the fuel cell stack in a closed state and stopping the operation of an air compressor for supplying air to the fuel cell stack when entering an idle stop mode while the vehicle speed does not exceed a first threshold and the available output of a high-voltage battery exceeds a second threshold.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to various aspects of the present disclosure, an apparatus for controlling an operation of a fuel cell system includes a first valve that is configured to control an amount of air supplied to a fuel cell stack, a second valve that discharges the air supplied to the fuel cell stack to an outside of the fuel cell stack, an air compressor that supplies the air to the fuel cell stack, a sensor configured for measuring that is configured for measuring a speed of a vehicle disposed with the fuel cell stack, and a controller that opens the first valve, closes the second valve, and operates the air compressor while driving, and closes the first valve, opens the second valve, and operates the air compressor when entering an idle stop mode while the speed of the vehicle exceeds a first threshold.

According to various aspects of the present disclosure, the apparatus may further include storage that stores a table in which an air supply amount corresponding to the speed of the vehicle and an available output of a high-voltage battery disposed in the vehicle is recorded.

According to various aspects of the present disclosure, the controller may be configured to determine the air supply amount of the air compressor based on the table.

According to various aspects of the present disclosure, the controller may obtain an altitude of a road on which the vehicle drives and apply a weight corresponding to the altitude to the air supply amount to determine a final air supply amount.

According to various aspects of the present disclosure, the controller may close the first valve, open the second valve, and operate the air compressor when an available output of a high-voltage battery disposed in the vehicle does not exceed a second threshold.

According to various aspects of the present disclosure, the controller may vary the first threshold based on the available output of the high-voltage battery.

According to various aspects of the present disclosure, the controller may vary the second threshold in proportion to an altitude of a road on which the vehicle drives.

According to various aspects of the present disclosure, the controller may vary the second threshold in proportion to a gradient of a road on which the vehicle drives.

According to various aspects of the present disclosure, the controller may close the first valve, open the second valve, and operate the air compressor when an available output of a high-voltage battery disposed in the vehicle does not cover an assist request amount.

According to various aspects of the present disclosure, the controller may maintain a closed state of the second valve and stop the operation of the air compressor when entering the idle stop mode while the speed of the vehicle does not exceed the first threshold and an available output of a high-voltage battery disposed in the vehicle exceeds a second threshold.

According to various aspects of the present disclosure, a method for controlling an operation of a fuel cell system includes measuring, by a sensor, a speed of a vehicle, entering, by a controller, an idle stop mode when the speed of the vehicle exceeds a first threshold, closing, by the controller, a first valve that is configured to control an amount of air supplied to a fuel cell stack, opening, by the controller, a second valve that discharges the air supplied to the fuel cell stack to an outside of the fuel cell stack, and operating, by the controller, an air compressor for supplying the air to the fuel cell stack.

According to various aspects of the present disclosure, the method may further include storing, by a storage, a table in which an air supply amount corresponding to the speed of the vehicle and an available output of a high-voltage battery disposed in the vehicle is recorded.

According to various aspects of the present disclosure, the method may further include determining, by the controller, the air supply amount of the air compressor based on the table.

According to various aspects of the present disclosure, the method may further include obtaining an altitude of a road on which the vehicle drives, and applying a weight corresponding to the altitude to the air supply amount to determine a final air supply amount.

According to various aspects of the present disclosure, the entering of the idle stop mode may include entering the idle stop mode when the speed of the vehicle exceeds a first threshold and an available output of a high-voltage battery disposed in the vehicle does not exceed a second threshold.

According to various aspects of the present disclosure, the entering of the idle stop mode may further include varying the first threshold based on the available output of the high-voltage battery.

According to various aspects of the present disclosure, the entering of the idle stop mode may further include varying the second threshold in proportion to an altitude of a road on which the vehicle drives.

According to various aspects of the present disclosure, the entering of the idle stop mode may further include varying the second threshold in proportion to a gradient of a road on which the vehicle drives.

According to various aspects of the present disclosure, the entering of the idle stop mode may further include closing the first valve, opening the second valve, and operating the air compressor when an available output of a high-voltage battery disposed in the vehicle does not cover an assist request amount.

According to various aspects of the present disclosure, a method for controlling an operation of a fuel cell system includes measuring, by a sensor, a speed of a vehicle, entering, by a controller, an idle stop mode while the speed of the vehicle does not exceed a first threshold and an available output of a high-voltage battery disposed in the vehicle exceeds a second threshold, maintaining, by the controller, a closed state of a valve that discharges air supplied to a fuel cell stack to an outside of the fuel cell stack, and stopping, by the controller, an operation of an air compressor for supplying the air to the fuel cell stack.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for controlling an operation of a fuel cell system according to an exemplary embodiment of the present disclosure;

FIG. 2 is a diagram illustrating a process in which an apparatus for controlling an operation of a fuel cell system according to an exemplary embodiment of the present disclosure operates in an idle stop mode;

FIG. 3 is a diagram illustrating a process in which an apparatus for controlling an operation of a fuel cell system according to another exemplary embodiment of the present disclosure operates in an idle stop mode;

FIG. 4 is a diagram illustrating a first example of the performance of an apparatus for controlling an operation of a fuel cell system according to an exemplary embodiment of the present disclosure;

FIG. 5 is a diagram illustrating a second example of the performance of an apparatus for controlling an operation of a fuel cell system according to an exemplary embodiment of the present disclosure;

FIG. 6 is a flowchart illustrating a method for controlling an operation of a fuel cell system according to an exemplary embodiment of the present disclosure;

FIG. 7 is a diagram illustrating the relationship between the available output of a high-voltage battery and a vehicle speed threshold according to an exemplary embodiment of the present disclosure; and

FIG. 8 is a block diagram illustrating a determining system for executing a method for controlling an operation of a fuel cell system according to various exemplary embodiments of the present disclosure.

### DETAILED DESCRIPTION

Hereinafter, various exemplary embodiments of the present disclosure will be described in detail with reference to the exemplary drawings. In adding the reference numerals to the components of each drawing, it should be noted that the identical or equivalent component is specified by the identical numeral even when they are displayed on other drawings. Furthermore, in describing the exemplary embodiment of the present disclosure, a detailed description of the related known configuration or function will be omitted when the controller concludes that it interferes with the understanding of the exemplary embodiment of the present disclosure.

Terms, such as first, second, A, B, (a), (b) or the like may be used herein when describing components of the present disclosure. The terms are disposed only to distinguish the elements from other elements, and the essences, sequences, orders, and numbers of the elements are not limited by the terms. Furthermore, unless defined otherwise, all terms used herein, including technical or scientific terms, include the same meanings as those generally understood by those skilled in the art to which the present disclosure pertains. The terms defined in the generally used dictionaries should be construed as including the meanings that coincide with the meanings of the contexts of the related technologies, and should not be construed as ideal or excessively formal meanings unless clearly defined in the specification of the present disclosure.

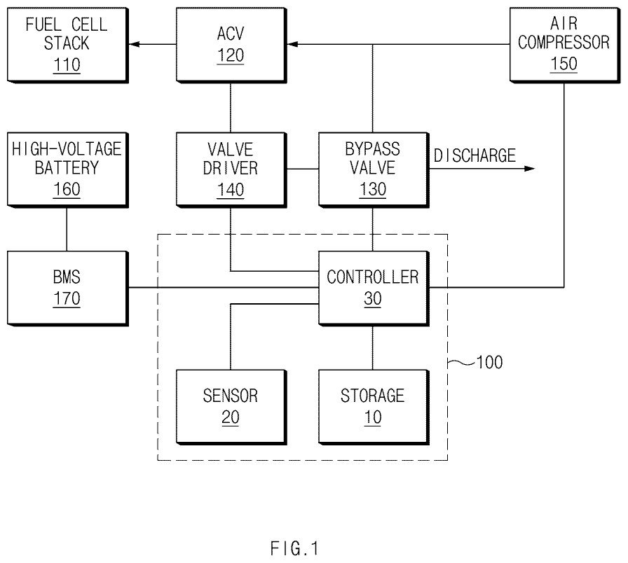

FIG. 1 is a block diagram illustrating an apparatus for controlling an operation of a fuel cell system according to an exemplary embodiment of the present disclosure.

In FIG. 1, an air flow control valve (ACV) 120 including an actuator may be configured for controlling the amount of air supplied from an air compressor 150 to the cathode of a fuel cell stack 110. A bypass valve 130 including an actuator may discharge the air supplied to the fuel cell stack 110 to an outside of the fuel cell stack. A valve driver 140, which is an actuator that is configured to control the opening amount of the ACV 120 and the opening and closing of the bypass valve 130, may include a first actuator for controlling the opening amount of the ACV 120 and a second actuator for controlling the opening and closing of the bypass valve 130. In the instant case, ACV 120 including an actuator such as mechanical actuator, pneumatic actuator, or electric actuator such as a motor but not limited thereto. The air compressor 150 may supply air to the cathode of the fuel cell stack 110. In the instant case, a driving level (or driving revolutions per minute (RPM)) of the air compressor 150 may be determined by a controller 30. A high-voltage battery 160 may supply driving power to a fuel cell vehicle. A battery management system (BMS) 170 may perform overall management of the high-voltage battery 160, and in particular, may be configured to determine an available output of the high-voltage battery 160.

In an exemplary embodiment of the present disclosure, an example is described in which the ACV 120 and the bypass valve 130 are implemented as separate structures, but in another exemplary embodiment of the present disclosure, the ACV 120 and the bypass valve 130 may be implemented as a single structure.

Meanwhile, an apparatus 100 for controlling an operation of a fuel cell system according to an exemplary embodiment of the present disclosure may include storage 10, a sensor 20, and the controller 30. In the instant case, depending on a scheme of implementing the apparatus 100 for controlling an operation of a fuel cell system according to an exemplary embodiment of the present disclosure, components may be combined with each other to be implemented as one, or some components may be omitted.

Regarding each component, first, the storage 10 may store a lookup table (hereinafter, referred to as an air supply table) in which air supply amounts corresponding to vehicle speeds and available outputs of the high-voltage battery 160 are recorded. For example, the air supply table is as shown in Table 1 below.

TABLE 1
Air supply amount

| | | Vehicle speed | | |
|---|---|---|---|---|
| | | 0 | 30 | 60 |
| Available output | 40 | 10 | 30 | 50 |
| of high-voltage | 20 | 10 | 50 | 70 |
| battery | 0 | 10 | 80 | 100 |

As illustrated in Table 1, the faster the vehicle speed, the more the air supply amount increases, and the lower the available output of the high-voltage battery, the more the air supply amount increases.

The storage 10 may store various logic, algorithms and programs required in a process of closing the ACV 120 that controls the amount of air supplied to the fuel cell stack 110, opening the bypass valve 130 that discharges the air supplied to the fuel cell stack 110 to an outside of the fuel cell stack, and operating the air compressor 150 that supplies air to the fuel cell stack 110 when entering an idle stop mode.

The storage 10 may store various logic, algorithms and programs required in a process of closing the ACV 120 that controls the amount of air supplied to the fuel cell stack 110, opening the bypass valve 130 that discharges the air supplied to the fuel cell stack 110 to an outside of the fuel cell stack, and operating the air compressor 150 that supplies air to the fuel cell stack 110 when entering the idle stop mode while the vehicle speed exceeds a threshold.

The storage 10 may store various logic, algorithms and programs required in a process of closing the ACV 120 that controls the amount of air supplied to the fuel cell stack 110, opening the bypass valve 130 that discharges air supplied to the fuel cell stack 110 to an outside of the fuel cell stack, and operating the air compressor 150 that supplies air to the fuel cell stack 110 when entering the idle stop mode while the vehicle speed exceeds a first threshold and the available output of the high-voltage battery does not exceed a second threshold.

The storage 10 may store various logic, algorithms and programs required in a process of maintaining the bypass valve 130 for discharging air supplied to the fuel cell stack 110 to an outside of the fuel cell stack in a closed state and stopping the operation of the air compressor 150 for supplying air to the fuel cell stack 110 when entering the idle stop mode while the vehicle speed does not exceed the first threshold and the available output of the high-voltage battery exceeds the second threshold.

The sensor 20 may measure the vehicle speed, the altitude of the area where the vehicle is located, and the gradient of the road on which the vehicle drives. The sensor 20 may include a speed sensor, an altitude sensor, and a gradient sensor.

The controller 30 is operatively connected to the BMS 170, the valve driver 140, the bypass valve 130 the ACV 120, the air compressor 150, the sensor 20 and the storage 10.

The controller 30 may be electrically connected to each component and may perform overall control so that each component performs function thereof. The controller 30 may be implemented in a form of hardware or software, or may be implemented in a combination of hardware and software. The controller 30 may be implemented as a microprocessor, but is not limited thereto.

The controller 30 may obtain the vehicle speed, the altitude of the area where the vehicle is located, and the gradient of the road on which the vehicle drives from the sensor 20. In the instant case, the vehicle network may include a Controller Area Network (CAN), a controller area network with flexible data-rate (CAN FD), a Local Interconnect Network (LIN), FlexRay, Media Oriented Systems Transport (MOST), an Ethernet, and the like.

The controller 30 may open the ACV 120 that controls the amount of air supplied to the fuel cell stack 110, close the bypass valve 130 that discharges the air supplied to the fuel cell stack 110 to an outside of the fuel cell stack, and operate the air compressor 150 that supplies air to the fuel cell stack 110 when driving.

The controller 30 may close the ACV 120 that controls the amount of air supplied to the fuel cell stack 110, open the bypass valve 130 that discharges the air supplied to the fuel cell stack 110 to an outside of the fuel cell stack, and operate the air compressor 150 that supplies air to the fuel cell stack 110 when entering an idle stop mode while driving.

The controller 30 may close the ACV 120 that controls the amount of air supplied to the fuel cell stack 110, open the bypass valve 130 that discharges the air supplied to the fuel cell stack 110 to an outside of the fuel cell stack, and operate the air compressor 150 that supplies air to the fuel cell stack 110 when entering the idle stop mode while the vehicle speed exceeds a threshold.

In the instant case, the controller 30 may vary the threshold based on the available output of the high-voltage battery 160. That is, the controller 30 may increase the threshold as the available output of the high-voltage battery 160 increases, and may decrease the threshold as the available output of the high-voltage battery 160 decreases. For example, in a state where the available output of the high-voltage battery 160 is A1 and the threshold is T1, when the available output of the high-voltage battery 160 decreases from A1 to A2, the threshold may decrease from T1 to T2.

When entering the idle stop mode while the vehicle speed exceeds the first threshold and the available output of the high-voltage battery 160 does not exceed the second threshold, the controller 30 may close the ACV 120 that controls the amount of air supplied to the fuel cell stack 110, open the bypass valve 130 that discharges air supplied to the fuel cell stack 110 to an outside of the fuel cell stack, and operate the air compressor 150 that supplies air to the fuel cell stack 110.

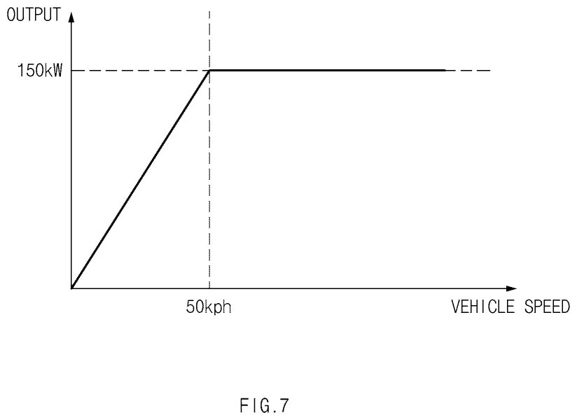

In the instant case, the controller 30 may vary the first threshold based on the available output of the high-voltage battery 160. That is, the controller 30 may increase the first threshold as the available output of the high-voltage battery 160 increases, and may decrease the first threshold as the available output of the high-voltage battery 160 decreases. For example, in a state where the available output of the high-voltage battery 160 is A1 and the first threshold is T1, when the available output of the high-voltage battery 160 decreases from A1 to A2, the first threshold may decrease from T1 to T2. The relationship between the available output of the high-voltage battery 160 and the first threshold (i.e., the vehicle speed threshold) is as illustrated in FIG. 7. The graph shown in FIG. 7 may vary depending on the characteristics of the vehicle. In the instant case, the vehicle characteristics may include motor output, motor output responsiveness, stack output, stack output responsiveness, maximum output of the high-voltage battery 160, and the like.

Furthermore, when the output to be assisted by the high-voltage battery 160 (i.e., the assist request amount) exceeds the available output of the high-voltage battery 160, i.e., when the available output of the high-voltage battery 160 does not cover the assist request amount and the idle stop mode is entered, the controller 30 may close the ACV 120 that controls the amount of air supplied to the fuel cell stack 110, open the bypass valve 130 that discharges the air supplied to the fuel cell stack 110 to an outside of the fuel cell stack, and operate the air compressor 150 that supplies air to the fuel cell stack 110. In general, a first assist request amount for the high-voltage battery 160 when entering the idle stop mode while driving is different from a second assist request amount for the high-voltage battery 160 when entering the idle stop mode while stopped. That is, the first assist request amount is greater than the second assist request amount. As a result, the controller 30 may consider the entry into the idle stop mode in various states of the vehicle (i.e., while driving or stopped) by comparing the available output of the high-voltage battery 160 and the assist request amount. Furthermore, the controller 30 may vary the second threshold based on the altitude of the area where the vehicle is located. That is, the controller 30 may increase the second threshold as the altitude of the area increases, and may decrease the second threshold as the altitude of the area decreases. For example, when the altitude of the area is H1 and the second threshold is K1, the second threshold may increase from K1 to K2 as the altitude of the area increases from H1 to H2.

Furthermore, the controller 30 may vary the second threshold based on the gradient of the road on which the vehicle drives. That is, the controller 30 may increase the second threshold as the gradient of the road increases, and may decrease the second threshold as the gradient of the road decreases. For example, when the gradient of a road is U1 and the second threshold is S1, the second threshold may increase from S1 to S2 as the gradient of the road increases from U1 to U2.

Thereafter, when the idle stop mode is released, the controller 30 may open the ACV 120 that controls the amount of air supplied to the fuel cell stack 110, close the bypass valve 130 that discharges the air supplied to the fuel cell stack 110 to an outside of the fuel cell stack, and control the operation of the air compressor 150 to supply the amount of air required by the fuel cell stack 110.

When entering the idle stop mode while the vehicle speed does not exceed the first threshold and the available output of the high-voltage battery exceeds the second threshold, the controller 30 may maintain the bypass valve 130 for discharging air supplied to the fuel cell stack 110 to an outside of the fuel cell stack in a closed state and may stop the operation of the air compressor 150 for supplying air to the fuel cell stack 110.

Thereafter, when the idle stop mode is released, the controller 30 may be configured for controlling the operation of the air compressor 150 to maintain the closed state of the bypass valve 130 that discharges the air supplied to the fuel cell stack 110 to an outside of the fuel cell stack and supply the amount of air required by the fuel cell stack 110.

Meanwhile, the controller 30 may obtain the vehicle speed and the available output of the high-voltage battery 160, and may be configured to determine the primary air supply amount corresponding to the vehicle speed and the available output of the high-voltage battery 160 based on the air supply amount table stored in the storage 10.

Thereafter, the controller 30 may obtain the altitude of the road on which the vehicle drives and apply a weight corresponding to the altitude to the primary air supply amount to determine the final air supply amount.

For example, when the altitude of the road on which the vehicle drives exceeds a reference altitude, a weight corresponding to the altitude is applied to increase the final air supply amount compared to the primary air supply amount, and when the altitude is included in the reference altitude, no weight is applied.

The final air supply amount may be used to determine the air supply amount required by the fuel cell stack 110 to supply the power required by the vehicle when the idle stop mode is released. In the instant case, the output delay of the fuel cell stack 110 may be prevented when the idle stop mode is released due to the final air supply amount.

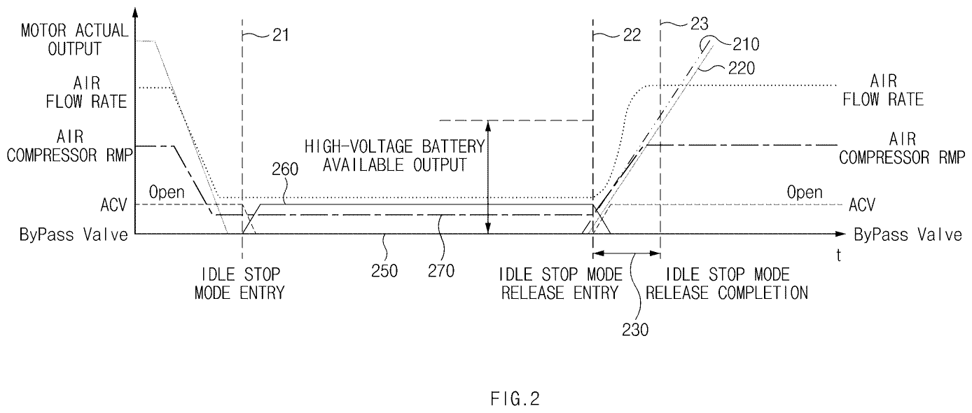

FIG. 2 is a diagram illustrating a process in which an apparatus for controlling an operation of a fuel cell system according to an exemplary embodiment of the present disclosure operates in an idle stop mode.

As illustrated in FIG. 2, in the section between an idle stop mode entry time point 21 and an idle stop mode release entry time point 22, the ACV 120 that controls the amount of air supplied to the fuel cell stack 110 is in a closed state 250, the bypass valve 130 that discharges the air supplied to the fuel cell stack 110 to an outside of the fuel cell stack is in an open state 260, and the air compressor 150 that supplies air to the fuel cell stack 110 is in an operating state 270.

As a result, an actual output 220 of the drive motor follows an ideal motor output 210, and it may be confirmed that the time point 230 from the idle stop mode release entry time point 22 to an idle stop mode release completion time point 23, that is. the output delay of the fuel cell stack 110 is improved.

Ultimately, when the vehicle speed exceeds the first threshold and the available output of the high-voltage battery 160 does not exceed the second threshold, the first operation of the controller 30 upon entering the idle stop mode is suitable for a driving situation that requires a fast response of the fuel cell stack 110.

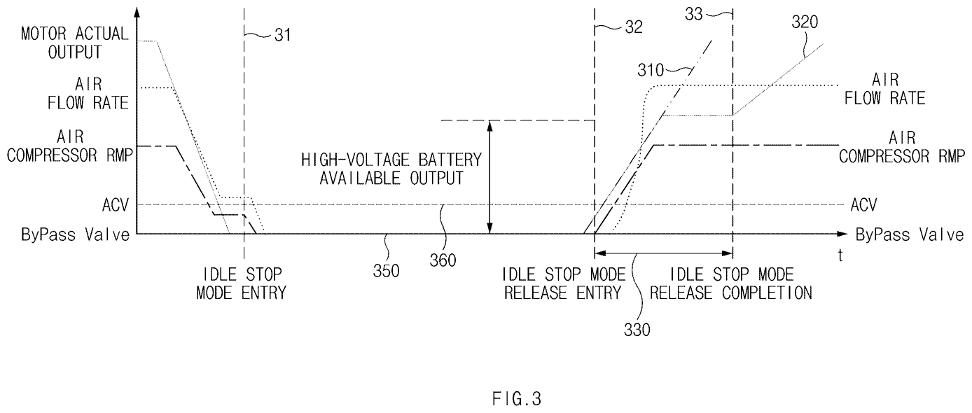

FIG. 3 is a diagram illustrating a process in which an apparatus for controlling an operation of a fuel cell system according to another exemplary embodiment of the present disclosure operates in an idle stop mode.

As illustrated in FIG. 3, in the section between the time point 31 of entering the idle stop mode and the time point 32 of releasing the idle stop mode, the bypass valve 130 that discharges air supplied to the fuel cell stack 110 to an outside of the fuel cell stack is maintained in a closed state 350, and the air compressor 150 that supplies air to the fuel cell stack 110 is in a stopped state 350. In the instant case, the ACV 120 maintains a constantly open state 360.

As a result, a gap may occur between an actual output 320 of a drive motor and an ideal motor output 310, and also, a delay in the output of the fuel cell stack 110 may occur during the time 330 from the time of entry into the idle stop mode release 32 to the time of completion of the idle stop mode release 33, but the fuel efficiency of the fuel cell vehicle may be improved.

Ultimately, a second operation of the controller 30 upon entry into the idle stop mode is suitable for a driving situation in which a fast response of the fuel cell stack 110 is not required, while the vehicle speed does not exceed the first threshold and the available output of the high-voltage battery 160 exceeds the second threshold.

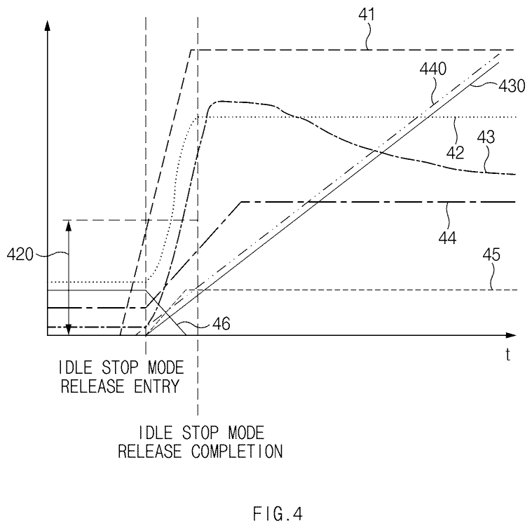

FIG. 4 is a diagram illustrating a first example of the performance of an apparatus for controlling an operation of a fuel cell system according to an exemplary embodiment of the present disclosure, and illustrates the performance when a fuel cell vehicle starts from a stationary state.

In FIG. 4, reference numeral 41 indicates the required output of the drive motor, reference numeral 42 indicates the air flow rate supplied to the fuel cell stack 110, reference numeral 43 indicates the voltage of the fuel cell stack 110, reference numeral 44 indicates the revolutions per minute (rpm) of the air compressor 150, reference numeral 45 indicates whether the ACV 120 is open or closed, and reference numeral 46 indicates whether the bypass valve 130 is open or closed.

For reference, before the idle stop mode release entry time point, the ACV 120 is closed and the bypass valve 130 is open, but between the idle stop mode release entry time point and the idle stop mode release completion time point, the states of the ACV 120 and the bypass valve 130 change, so that after the idle stop mode release completion time point, the ACV 120 is opened and the bypass valve 130 is closed.

When the fuel cell vehicle starts from a stationary state, the vehicle speed increases and the available output of the high-voltage battery 160 decreases at 420. In the instant case, the RPM of the drive motor slowly increases. When entering the idle stop mode in the instant state, the controller 30 closes the ACV 120 that controls the amount of air supplied to the fuel cell stack 110, opens the bypass valve 130 that discharges the air supplied to the fuel cell stack 110 to an outside of the fuel cell stack, and operates the air compressor 150 that supplies air to the fuel cell stack 110.

As a result, the actual output 430 of the drive motor follows an ideal motor output 440, and also, the time from the time point of entering the idle stop mode release to the time point of completing the release of the idle stop mode, that is, the output delay of the fuel cell stack 110 is improved.

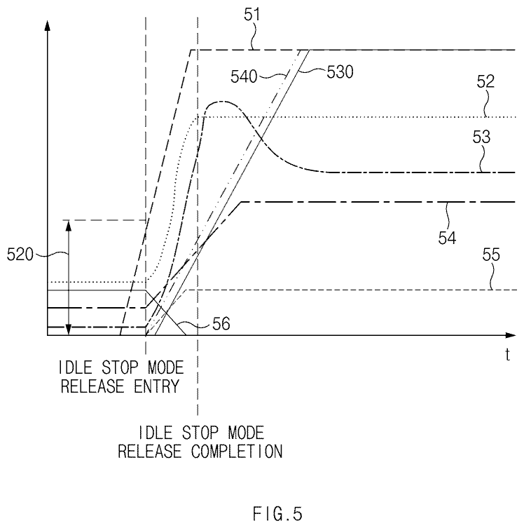

FIG. 5 is a diagram illustrating a second example of the performance of an apparatus for controlling an operation of a fuel cell system according to an exemplary embodiment of the present disclosure, and illustrates a case where a fuel cell vehicle starts while in a driving state.

In FIG. 5, reference numeral 51 indicates the required output of the drive motor, reference numeral 52 indicates the air flow rate supplied to the fuel cell stack 110, reference numeral 53 indicates the voltage of the fuel cell stack 110, reference numeral 54 indicates the RPM of the air compressor 150, reference numeral 55 indicates whether the ACV 120 is opened or closed, and reference numeral 56 indicates whether the bypass valve 130 is opened or closed.

For reference, before the idle stop mode release entry time point, the ACV 120 is closed and the bypass valve 130 is open, but between the idle stop mode release entry time point and the idle stop mode release completion time point, the states of the ACV 120 and the bypass valve 130 change, so that after the idle stop mode release completion time point, the ACV 120 is open and the bypass valve 130 is closed.

When a fuel cell vehicle starts while driving, the vehicle speed increases and the available output of the high-voltage battery 160 decreases at 420. In the instant case, the RPM of the drive motor increases rapidly. When entering the idle stop mode in the instant state, the controller 30 closes the ACV 120 that controls the amount of air supplied to the fuel cell stack 110, opens the bypass valve 130 that discharges the air supplied to the fuel cell stack 110 to an outside of the fuel cell stack, and operates the air compressor 150 that supplies air to the fuel cell stack 110.

As a result, the actual output 530 of the drive motor follows an ideal motor output 540, and also, the time from the time point of entering the idle stop mode release to the time point of completing the release of the idle stop mode, that is, the output delay of the fuel cell stack 110 is improved.

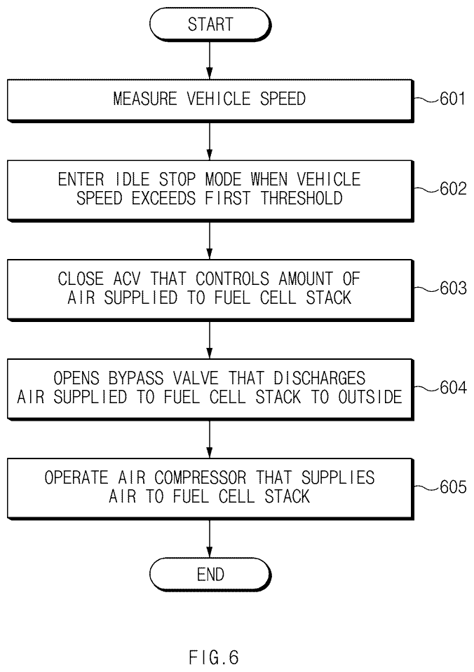

FIG. 6 is a flowchart illustrating a method for controlling an operation of a fuel cell system according to an exemplary embodiment of the present disclosure.

First, in 601, the sensor 20 measures the speed of the vehicle.

Accordingly, in 602, when the speed of the vehicle exceeds the first threshold, the controller 30 enters the idle stop node.

Accordingly, in 603, the controller 30 closes the ACV (first valve) that is configured to control the amount of air supplied to the fuel cell stack 110.

Accordingly, in 604, the controller 30 opens the bypass valve (second valve) that discharges the air supplied to the fuel cell stack 110 to an outside of the fuel cell stack.

Accordingly, in 605, the controller 30 operates the air compressor 150 that supplies air to the fuel cell stack 110.

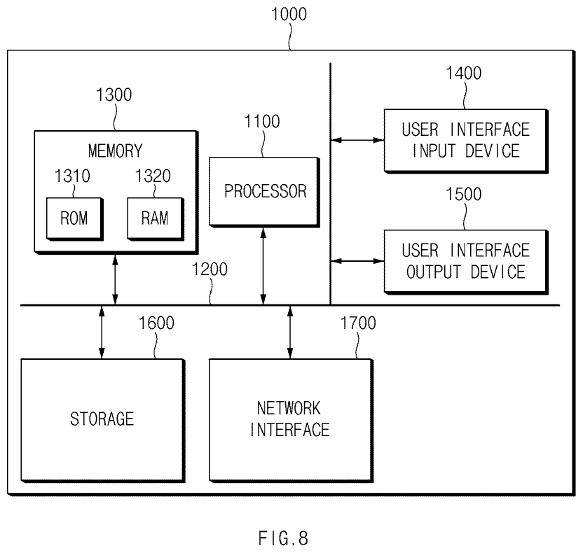

FIG. 8 is a block diagram illustrating a computing system for executing a method for controlling an operation of a fuel cell system according to various exemplary embodiments of the present disclosure.

Referring to FIG. 8, as described above, the method for controlling an operation of a fuel cell system according to an exemplary embodiment of the present disclosure may be implemented through a computing system 1000. The computing system 1000 may include at least one processor 1100, a memory 1300, a user interface input device 1400, a user interface output device 1500, storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to the exemplary embodiments of the present disclosure, it is possible to prevent an output delay (or response delay) of a fuel cell stack that occurs when an idle stop mode is released by closing an air flow control valve (ACV) that is configured to control the amount of air supplied to the fuel cell stack, opening a bypass valve that discharges air supplied to the fuel cell stack to an outside of the fuel cell stack, and operating an air compressor that supplies air to the fuel cell stack when entering the idle stop mode.

Although exemplary embodiments of the present disclosure have been described for illustrative purposes, those skilled in the art will appreciate that various modifications, additions and substitutions are possible, without departing from the scope and spirit of the present disclosure. Therefore, the exemplary embodiment of the present disclosure are disposed for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling an operation of a fuel cell system, the apparatus comprising:
an air compressor supplying an air to the fuel cell stack;
a first valve connected to the fuel cell stack and the air compressor and controlling an amount of air supplied to the fuel cell stack from the air compressor;
a second valve connected to the first valve and the air compressor and configured for discharging the air supplied to the fuel cell stack to an outside of the fuel cell stack;
a sensor measuring a speed of a vehicle disposed with the fuel cell stack; and
a controller operatively connected to the air compressor, the first valve, the second valve, and the sensor, and configured for:
opening the first valve, closing the second valve, and operating the air compressor while driving, and
closing the first valve, opening the second valve, and operating the air compressor when entering an idle stop mode while the speed of the vehicle exceeds a first threshold.

2. The apparatus of claim 1, further comprising:
a storage operatively connected to the controller and configured for storing a table in which an air supply amount corresponding to the speed of the vehicle and an available output of a battery disposed in the vehicle is recorded.

3. The apparatus of claim 2, wherein the controller determines the air supply amount of the air compressor based on the table.

4. The apparatus of claim 3, wherein the controller
obtains an altitude of a road on which the vehicle drives, and
applies a weight corresponding to the altitude to the air supply amount to determine a final air supply amount.

5. The apparatus of claim 1, wherein the controller closes the first valve, opens the second valve, and operates the air compressor based on that an available output of a battery disposed in the vehicle does not exceed a second threshold.

6. The apparatus of claim 5, wherein the controller varies the first threshold based on the available output of the battery.

7. The apparatus of claim 5, wherein the controller varies the second threshold in proportion to an altitude of a road on which the vehicle drives.

8. The apparatus of claim 5, wherein the controller varies the second threshold in proportion to a gradient of a road on which the vehicle drives.

9. The apparatus of claim 1, wherein the controller closes the first valve, opens the second valve, and operates the air compressor based on that an available output of a battery disposed in the vehicle does not cover an assist request amount.

10. The apparatus of claim 1, wherein the controller maintains a closed state of the second valve and stops operation of the air compressor when entering the idle stop mode while the speed of the vehicle does not exceed the first threshold and an available output of a battery disposed in the vehicle exceeds a second threshold.

11. A method for controlling an operation of a fuel cell system, the method comprising:
measuring, by a sensor, a speed of a vehicle;
entering, by a controller operatively connected to the sensor, an idle stop mode based on that the speed of the vehicle exceeds a first threshold;
closing, by the controller, a first valve that controls an amount of air supplied to a fuel cell stack;
opening, by the controller, a second valve that discharges the air supplied to the fuel cell stack to an outside of the fuel cell stack; and
operating, by the controller, an air compressor for supplying the air to the fuel cell stack.

12. The method of claim 11, further comprising:
storing, by a storage, a table in which an air supply amount corresponding to the speed of the vehicle and an available output of a battery disposed in the vehicle is recorded.

13. The method of claim 12, further comprising:
determining, by the controller, the air supply amount of the air compressor based on the table.

14. The method of claim 13, further comprising:
obtaining, by the controller, an altitude of a road on which the vehicle drives; and
applying, by the controller, a weight corresponding to the altitude to the air supply amount to determine a final air supply amount.

15. The method of claim 11, wherein the entering of the idle stop mode includes entering the idle stop mode based on that the speed of the vehicle exceeds a first threshold and an available output of a battery disposed in the vehicle does not exceed a second threshold.

16. The method of claim 15, wherein the entering of the idle stop mode further includes varying the first threshold based on the available output of the battery.

17. The method of claim 15, wherein the entering of the idle stop mode further includes varying the second threshold in proportion to an altitude of a road on which the vehicle drives.

18. The method of claim 15, wherein the entering of the idle stop mode further includes varying the second threshold in proportion to a gradient of a road on which the vehicle drives.

19. The method of claim 11, wherein the entering of the idle stop mode further includes closing the first valve, opening the second valve, and operating the air compressor based on that an available output of a battery disposed in the vehicle does not cover an assist request amount.

20. A method for controlling an operation of a fuel cell system, the method comprising:
measuring, by a sensor, a speed of a vehicle;
entering, by a controller operatively connected to the sensor, an idle stop mode while the speed of the vehicle does not exceed a first threshold and an available output of a battery disposed in the vehicle exceeds a second threshold;
maintaining, by the controller, a closed state of a valve that discharges air supplied to a fuel cell stack to an outside of the fuel cell stack; and
stopping, by the controller, an operation of an air compressor configured for supplying the air to the fuel cell stack.
